(19) United States
(12) Patent Application Publication
(10) Pub. No.: US 2013/0078512 A1
(43) Pub. Date: Mar. 28, 2013

(54) LITHIUM SECONDARY BATTERY

(71) Applicant: NEC Tokin Corporation, Sendai (JP)

(72) Inventors: Takehiro Noguchi, Sendai (JP); Masaaki Matsuu, Sendai (JP); Ryuichi Kasahara, Sendai (JP); Tatsuji Numata, Sendai (JP); Yutaka Bannai, Sendai (JP)

(73) Assignee: NEC TOKIN CORPORATION, Sendai (JP)

(21) Appl. No.: 13/684,028

(22) Filed: Nov. 21, 2012

Related U.S. Application Data
(63) Continuation of application No. 13/225,244, filed on Sep. 2, 2011.
Application No. 13/225,244 is a continuation of application No. 12/725,756, filed on Mar. 17, 2010, now abandoned.
Application No. 12/725,756 is a division of application No. 11/626,718, filed on Jan. 24, 2007, now abandoned.

(30) Foreign Application Priority Data
Jan. 25, 2006 (JP) 2006-016131

(51) Int. Cl. H01M 4/505

(52) U.S. Cl. CPC H01M 4/505
USPC 429/211; 429/223; 429/221; 429/220; 252/182.1; 252/519.1; 252/519.12; 252/519.15

(57) ABSTRACT

An objective of the present invention is to provide a lithium secondary battery which can achieve a higher capacity and a longer life without reduction in a lower voltage in the battery. In the present invention, a compound represented by general formula (I) described below is used as a cathode active material, and a compound represented by general formula (II) described below is used as an anode active material,

Liₐ₁(Niₓ₁Mn_{2-x1-y1}M1_{y1})O₄ (I)
wherein the M1 is at least one of Ti, Si, Mg and Al, the a1 satisfies 0≦a1≦1, the x1 satisfies 0.4≦x1≦0.6, and the y1 satisfies 0≦y1≦0.4; and

Liₐ₂M2_{1-y2}M3_{y2}O_{z2} (II)
wherein the M2 is at least one of Si and Sn; the M3 is at least one of Fe, Ni and Cu, the a2 satisfies 0≦a2≦5, the y2 satisfies 0≦y2<0.3, and the z2 satisfies 0<z2<2.

### CROSS-REFERENCE TO RELATED APPLICATIONS

This application is a continuation of U.S. application Ser. No. 13/225,244, filed on Sep. 2, 2011, which is a continuation of U.S. application Ser. No. 12/725,756, filed on Mar. 17, 2010, which is a division of application Ser. No. 11/626,718, filed on Jan. 24, 2007, which claims priority to Japanese Patent Application No, 2006-016131, filed Jan. 25, 2006, which are hereby incorporated by reference in their entirety.

### BACKGROUND OF THE INVENTION

1. Field of the Invention

The present invention relates to an active material for a lithium secondary battery and a lithium secondary battery therewith, in particular to a method for achieving a high energy density and improving a cycle life.

2. Description of the Prior Art

A lithium secondary battery which has a feature of a large capacity in a small size has been extensively used as a power source for a cell phone, a notebook computer and the like,. Herein, a “lithium secondary battery” is a battery in which each of a cathode and an anode contains an active material capable of inserting and releasing lithium ions and which operates by transfer of lithium ions in an electrolyte. Materials for the anode active material include those capable of inserting and releasing lithium ions such as carbon materials, as well as Li and metal materials such as Al which is capable of forming an alloy with Li.

Examples of the cathode active material for the lithium secondary battery include layered-structure materials such as LiCoO₂, LiNiO₂ and LiNi_{1/3}Co_{1/3}Mn_{1/3}O₂. These materials have a feature of a discharge capacity of 150 mAh/g or more and an average discharge potential of 3.7 V to 4.0 V to Li. Other examples of the cathode active material include spinel-structure materials represented by LiMn₂O₄. These materials have a discharge capacity of about 110 mAh/g and an average discharge potential of about 4.0 V to Li, indicating a lower energy density than that of the layered structure material, but has advantages of a lower cost because of containing Mn as a main component and of higher thermal stability during charging. There has been investigated the use of LiNi_{0.5}Mn_{1.5}O₄ which has the same structure as LiMn₂O₄ and exhibits a higher charge/discharge potential. The material has a discharge capacity of about 135 mAh/g and an average discharge potential of about 4.6 V to Li, which is equivalent to, for example, LiCoO₂ in terms of an energy density. Examples of other cathode active material materials which operate at a high voltage include LiCoPO₄, LiCoMnO₄ and LiCrMnO₄, but any of these has an excessively higher potential and thus suffers from reduction in a battery capacity with decomposition of an electrolyte.

On the other hand, as the anode active material in the lithium secondary battery, graphite is predominantly used in the lithium secondary battery with a high energy density, but there have been needs for further increasing an energy density. As the anode active material for improving the capacity, there have been reported Si, Sn and alloys therewith, Si oxides, Sn oxides, Li—Co nitrides, and so forth. These anode active materials have a higher charge/discharge potential than that of graphite and has an average discharge potential of 0.2 to 2.5 V to Li. There has been, thus, a problem of a lower battery discharge voltage than a conventional battery. In particular, when using any of these anode active material materials, a lower-limit of a working voltage in a battery is reduced, so that in a voltage range used in a conventional battery, a capacity is adversely lower.

These high-capacity anode active materials further have a problem in terms of cycle properties. Japanese Patent Application Laid-Open No. 2001-210326 has disclosed a combination of a cathode active material which can charge/discharge at a high potential and a high-capacity anode active material. There has been, however, room for improvement in a capacity and cycle properties because the compositions of the cathode and the anode active materials have not been fully optimized. Japanese Patent Application Laid-Open No. 2003-197194 has described an example using LiNi_{0.5}Mn_{1.35}Ti_{0.15}O₄ or the like, but there have been needs for a battery with a further higher capacity. Japanese Patent No. 3010226 has described an example in which a metal element is added to the anode active material, but for balancing a high capacity with a longer life in a battery, a combination of the cathode and the anode active materials as well as their compositions must be optimized.

Thus, there still remain problems in improving a capacity in a lithium secondary battery.

Therefore, an objective of the present invention is to provide a lithium secondary battery which can achieve a higher capacity and a longer life without reduction in a lower voltage in the battery.

### SUMMARY OF THE INVENTION

The present invention provides a lithium secondary battery, comprising a compound represented by general formula (I) described below as a cathode active material, and a compound represented by general formula (II) described below as an anode active material;

Liₐ₁(Niₓ₁Mn_{2-x1-y1}M1_{y1})O₄ (I)

wherein the M1 is at least one of Ti, Si, Mg and Al, the a1 satisfies 0≦a1≦1, the x1 satisfies 0.4≦x1≦0.6, and the y1 satisfies 0≦y1≦0.4; and

Liₐ₂M2_{1-y2}M3_{y2}O_{z2} (II)

wherein the M2 is at least one of Si and Sn; the M3 is at least one of Fe, Ni and Cu, the a2 satisfies 0≦a2≦5, the y2 satisfies 0≦y2≦0.3, and the z2 satisfies 0<z2<2.

There is provided the lithium secondary battery wherein the a2 satisfies 0.5≦a2≦2.5 in the general formula (II).

There is provided the lithium secondary battery wherein the y2 satisfies 0.05≦y2≦0.3 in the general formula (II).

There is provided the lithium secondary battery wherein the y2 satisfies 0.05≦y2≦0.3 in the general formula (II).

This invention attempts to achieve a high energy density in a battery and to ensure its cycle life.

In the prior art, a battery employing Si or Sn as an anode active material for increasing an energy density has the problem of reduction in a working voltage. When using Si or Sn, a charge/discharge potential range is 0.1 to about 2.5 V to Li and there exists a charge/discharge capacity of 10% or more of the total even in a range of 1.0 V to 2.5 V On the other hand, when using LiCoO₂ or LiMn₂O₄ as a cathode active material, a cathode charge/discharge potential is around 3.6 V to 4.0 V, so that when being combined with any of the above anode active materials, the battery resultantly has charge/discharge range below 3 V mainly. Since a working voltage range of a conventional lithium battery is designed to have a lower limit of about 3 V and an operating device is also optimized to the range, a discharge capacity of 3 V or higher becomes a substantially available capacity, but it can not been expected that the substantial capacity is significantly increased. Furthermore, reduction in the battery voltage is directly associated with reduction in an energy density.

Since the present invention employs LiNi_{0.5}Mn_{1.5}O₄ having a high capacity in a potential range of 4.5 V or higher to Li to keep a battery working voltage high, an energy density can be effectively increased, to provide a battery which ensures a high capacity even in a voltage range for a conventional battery and is improved in its life.

In the general formula (I), the x1 range of 0.4≦x1≦0.6 leads to a higher discharge capacity in a potential range of 4.5 V or higher, so that a substantial battery capacity can be effectively increased. Furthermore, when the y1 satisfies 0<y1≦0.4 and M1 contains Al, Mg, Si or Ti in place of Mn in the general formula (I), cycle properties can be further improved while maintaining a high capacity. Furthermore, a complex oxide consisting of Li and Si or Sn can be used as the anode active material to make cycle properties satisfactory and when Ni, Fe and Cu are contained in a range of less than 30 atom %, cycle properties are further improved. A combination of them can provide a battery with a high capacity and a high energy density.

The first effect of the present invention is that a capacity can be increased to a compact and lightweight lithium secondary battery. The second effect of the present invention is that even when a capacity is increased, a lithium secondary battery with an equivalent voltage range can be provided. The third effect is that even when a capacity is increased, a lithium secondary battery with an improved cycle life can be provided.

### BRIEF DESCRIPTION OF THE DRAWINGS

FIG. 1 is a cross-sectional view of a lithium secondary battery according to the present invention: and

FIG. 2 is a discharge curve for the lithium secondary battery prepared in Experimental Example 1 according to the present invention.

### DETAILED DESCRIPTION OF PREFERRED EMBODIMENTS

There will be described embodiments of a lithium secondary battery according to the present invention.

A lithium secondary battery according to the present invention comprises, as main components, a cathode containing a lithium-containing metal compound as a cathode active material and an anode containing an anode active material which is capable of inserting and releasing lithium, where a separator is sandwiched between the cathode and the anode for preventing electric connection between them and the cathode and the anode are immersed in a lithium-ion conducting electrolyte. These are enclosed in a battery case. When applying a voltage between the cathode and the anode, lithium ions are released from the cathode active material and inserted into the anode active material, resulting in the state of charge. When the cathode and the anode are electrically connected outside of the battery, lithium ions are, oppositely to charging, released from the anode active material and inserted into the cathode active material to cause discharge.

In the present invention, a compound represented by general formula (I) described below is used as a cathode active material;

Liₐ₁(Niₓ₁Mn_{2-x1-y1}M1_{y1})O₄ (I)

wherein the M1 is at least one of Ti, Si, Mg and Al, the al satisfies 0≦a1≦1, the x1 satisfies 0.4≦x1≦0.6, and the y1 satisfies 0≦y1≦0.4.

In the general formula (I), the a1 is initially about 1 and as Li ions are released by charging, the al is decreased. On the contrary, as Li ions are inserted by discharging from the state of charge, the a1 is increased. In charge/discharge of the battery, such reactions reversibly occur. During the charge/discharge, the a1 varies within a range of 0≦a1≦1.

In the compound represented by the general formula (I), the x1 satisfies 0.4≦x1≦0.6 for ensuring a high capacity. It would be because a cathode active material having the composition of LiNi_{0.5}Mn_{1.5}O₄ or near has a flat and high-capacity charge/discharge curve in a potential range of 4.5 V to Li. In the general formula (I), the x1 preferably satisfies 0.45≦x1≦0.55.

In the compound represented by the general formula (I), Mn element may be replaced by another element which is the M1. In the general formula (I), the y1 satisfies 0≦y1≦0.4. The M1 is at least one of Ti, Si, Mg and Al. A given amount of Mn element can be replaced by another element which is the M1, to improve cycle properties while maintaining a high capacity. Therefore, in the general formula (I), the y1 satisfies preferably 0<y1≦0.4, more preferably 0.02≦y1≦0.2. The above effect is more prominent when the M1 contains Ti.

There will be described a process for manufacturing a cathode.

Examples of a Li raw material for the cathode active material include lithium salts such as Li₂CO₃, LiOH, LiNO₃ and Li₂SO₄; and Li₂O. Among them, Li₂CO₃ and LiOH are preferable because they are highly reactive to a transition metal material and CO₃ or OH group is vaporized as CO₂ or H₂O, respectively, during calcination, to give no adverse effects on the cathode active material. Examples of a Ni raw material include NiO, Ni(OH)₂, NiSO₄ and Ni(NO₃)₂. Examples of a Mn raw material include Mn oxides such as electrolytic manganese dioxide (EMD), Mn₂O₃ and Mn₃O₄; MnCO₃; and MnSO₄. Examples of a Ti raw material include Ti oxides such as Ti₂O₃ and TiO₂; Ti carbonates; Ti hydroxides; Ti sulfates; and Ti nitrates. Examples of an Mg raw material include Mg(OH)₂. Examples of an Al raw material include Al(OH)₃. Examples of a Si raw material include SiO and SiO₂.

These raw materials are weighed in such amounts that a desired metal composition ratio was obtained, and are pulverized and blended in a mortar or a ball mill. The blended powder can be calcined in the air, Ar or the oxygen at a temperature of 500° C. to 1200° C., to give a cathode active material. A higher calcination temperature is desirable for diffusing each element, but a too high calcination temperature may cause oxygen loss or aggregation of the active material to lose powder form, which may adversely affect properties when it is used as the cathode active material for the battery. The calcination temperature is, therefore, desirably about 500° C. to 900° C. Furthermore, it is preferable to conduct the calcination under the oxygen atmosphere for avoiding the oxygen loss.

A specific surface area of the cathode active material thus obtained is desirably 0.01 m²/g or more and 3 m²/g or less, preferably 0.1 m²/g or more and 1.5 m²/g or less. It is because a larger specific surface area requires more binder, which is disadvantageous in respect to a capacity density in the electrode and a too small specific surface area may reduce an ion conduction between an electrolyte and the active material. An average particle size of the cathode active material is preferably 0.1 μm or more and 50 μm or more, more preferably 1 μm or more and 20 μm or more. A too large particle size may cause irregularity such as asperity in the electrode layer during electrode deposition. A too small particle size may lead to poor adhesiveness of the electrode deposited.

The cathode active material thus obtained is combined with a conductivity-endowing material, and is applied, as a film, on a cathode collector via a binder, to give a cathode. Examples of the conductivity-endowing material include carbon materials such as acetylene black, carbon black, graphite and a fibrous carbon; metal materials such as Al; and conductive oxide powders. Examples of the binder include polyvinylidene fluoride. The cathode collector may be a metal film containing Al or Cu as a main component.

The content of the conductivity-endowing material is preferably about 0.5 to 30% by weight (to the total amount of the cathode active material, the conductivity-endowing material and the binder), and the content of the binder is about 1 to 10% by weight (to the total amount of the cathode active material, the conductivity-endowing material and the binder). A too small ratio of the conductivity-endowing material and the binder may lead to poor electron conductivity and detachment of the electrode. A too large ratio of the conductivity-endowing material and the binder may cause reduction in a capacity per battery weight. The content of the cathode active material is, therefore, preferably 70 to 98.5% by weight (to the total amount of the cathode active material, the conductivity-endowing material and the binder), more preferably, 85 to 97% by weight (to the total amount of the cathode active material, the conductivity-endowing material and the binder). A too small ratio of the cathode active material is disadvantageous in respect to an energy density in the battery. A too large ratio of the cathode active material is also disadvantageous in that the ratios of the conductivity-endowing material and the binder per battery weight are reduced, leading to deterioration in electron conductivity and tendency to detachment of the electrode.

In addition to the compound represented by the general formula (I), the cathode active material may contain a 5 V class spinel material such as LiCoₓMn₂₋ₓO₄ (0.4<x<1.1), LiFeₓMn₂₋ₓO₄ (0.4<x<1.1) and LiCrₓMn₂₋ₓO₄ (0.4<x<1.1); a layered-structure material containing Co, Mn or Ni as a main component which has a composition formula of LiMO₂ such as LiCoO₂, LiNi_{0.8}Co_{0.2}O₂ and LiNi_{1/3}Co_{1/3}Mn_{1/3}O₂; or a material having an olivine type crystal structure such as LiFePO₄, LiCoPO₄ and Li(FeNn)PO₄. The compound represented by the general formula (I) is preferably contained in 50% by weight or more in the cathode active material used in the lithium secondary battery.

In the present invention, a compound represented by general formula (II) described below is used as an anode active material;

Liₐ₂M2_{1-y2}M3_{y2}O_{z2} (II)

wherein the M2 is at least one of Si and Sn; the M3 is at least one of Fe, Ni and Cu, the a2 satisfies 0≦a2≦5, the y2 satisfies 0≦y2<0.3, and the z2 satisfies 0<z2<2.

In the general formula (II), the M2 contains at least one of Si and Sn. However, an anode active material containing Si or Sn has a drawback of a large irreversible capacity during initial charge/discharge, For improving the drawback, Li may be added in advance to reduce the irreversible capacity.

As the amount of Li added to the anode active material, the a2 satisfies preferably 0<a2≦4, more preferably 0.5≦a2≦2.5 in the general formula (II) in the initial state. A smaller amount of Li leads to increase in the irreversible capacity, which may cause reduction in a capacity as the lithium secondary battery. A larger amount of Li leads to reduction in a charge/discharge region associated with Li insertion/release, so that the battery capacity may be reduced. However, when the anode active material contains at least one of Fe, Ni and Cu which is the M3, these elements can reduce the irreversible capacity so that the amount of Li can be reduced; for example, the a2 may satisfy 0.5≦a2≦4 in the general formula (II) in the initial state. When Li is deposited by vapor deposition on a layer made of another anode active material (a lower layer), the two layer structure after the depositions becomes single-layered over time as Li is diffused into the lower layer. This reaction proceeds very slowly, but when the structure is immersed in an electrolyte, these layers are single-layered very rapidly to give a single anode active material. The anode active material thus prepared absorbs Li during charging while releasing Li during discharging. The lithium secondary battery operates based on the reversible reactions, where the a2 varies within 0≦a2≦5.

Since the compound represented by the general formula (II) is a complex oxide consisting of Li added as described above and Si or Sn, the z2 satisfies 0<z2<2, preferably 0.5≦z2≦1.5 in the general formula (II).

In the compound represented by the general formula (II), another element which is the M3 may be added and the y2 satisfies 0≦y2<0.3 in the general formula (II). The M3 is at least one of Fe, Ni and Cu. Addition of another element which is the M3 significantly improves cycle properties. Therefore, the y2 in the general formula (II) satisfies preferably 0<y2<0.3, more preferably 0.05≦y2≦0.2. The above effect is more prominent when the M3 contains Ni.

There will be described a process for manufacturing an anode.

Examples of a Li raw material for the anode active material include Li metal, Li₂O, Li(OH)₂ and Li₂CO₃. Examples of a Si raw material include Si oxides such as SiO and SiO₂; and Si. Examples of a Sn raw material include Sn oxides such as SnO; and Sn. A metal raw material added as the M3 may be each metal, and oxide, hydroxide or carbonate thereof.

These materials are deposited on an anode collector by a vacuum deposition process such as vapor deposition, to form an anode active material layer. Li added can be deposited on a layer made of an active material other than Li (a lower layer), to form a desired anode active material layer of a complex oxide. When two or more anode active materials other than Li are contained, they may be deposited by two-component simultaneous vapor deposition. The vacuum vapor deposition conditions can be controlled to adjust a target composition of the anode active material. The anode collector may be, for example, a Cu foil.

In addition to the vacuum deposition process, the anode active material may be prepared by fusing and mixing the raw materials in an inert gas atmosphere, allowing the mixture to be solidified and then pulverizing the solid, or by mixing the raw materials and then calcining the mixture, and subsequently an anode is formed on the anode collector as described for the cathode active material.

In this invention, an electrolyte obtained by dissolving an electrolyte-supporting salt in an electrolyte solvent is used.

The electrolyte solvent in the present invention may be selected from cyclic carbonates such as ethylene carbonate (EC), propylene carbonate (PC), butylene carbonate (BC) and vinylene carbonate (VC): linear carbonates such as dimethyl carbonate (DMC), ethyl methyl carbonate (EMC), diethyl carbonate (DEC) and dipropyl carbonate (DPC); aliphatic carboxylates such as methyl formate, methyl acetate and ethyl propionate; γ-lactones such as γ-butyrolactone, linear ethers such as 1,2-diethoxyethane (DEE) and ethoxymethoxyethane (EME): cyclic ethers such as tetrahydrofuran and 2-methyltetrahydrofuran; and aprotic organic solvents such as dimethylsulfoxide, 1,3-dioxolan, formamide, acetamide, dimethylformamide, dioxolan, acetonitrile, propionitrile, nitromethane, ethyl monoglyme, phosphoric acid triesters, trimethoxymethane, dioxolan derivatives, sulfolane, methylsulfolane, 1,3-dimethyl-2-imidazolidinone, 3-methyl-2-oxazolidinone, propylene carbonate derivatives, tetrahydrofuran derivatives, ethyl ether, 1,3-propanesultone, anisole, N-methylpyrrolidone and fluorocarboxylic acid esters, which can be used alone or in combination of two or more. Alternatively, it may be the electrolyte solvent which has gelated by adding a polymer. Among these, a combination of a cyclic carbonate and a linear carbonate is suitably used in the light of conductivity and stability at a high voltage.

A lithium salt as an electrolyte-supporting salt is dissolved into such an electrolyte solvent. Examples of the lithium salt include LiPF₆, LiAsF₆, LiAlCl₄, LiClO₄, LiBF₄, LiSbF₆, LiCF₃SO₃, LiC₄F₉SO₃, LiC(CF₃SO₂)₃, LiN(CF₃SO₂)₂, LiN(C₂F₅SO₂)₂, lithium lower aliphatic carboxylates, chloroborane lithium, lithium tetraphenylborate, LiBr, LiI, LiSCN, LiCl and LiF. A concentration of the electrolyte-supporting salt may be, for example, 0.5 to 1.5 mol/L. A too high concentration tends to increase a density and viscosity of the electrolytic solution, while a too low concentration may reduce an electric conductivity of the electrolyte.

A lithium secondary battery according to the present invention can be prepared by stacking or stacking and winding the cathode and the anode via the separator in a dry-air or inert-gas atmosphere and placing in a battery can or sealing, for example, with a film consisting of a laminate of a synthetic resin and a metal foil.

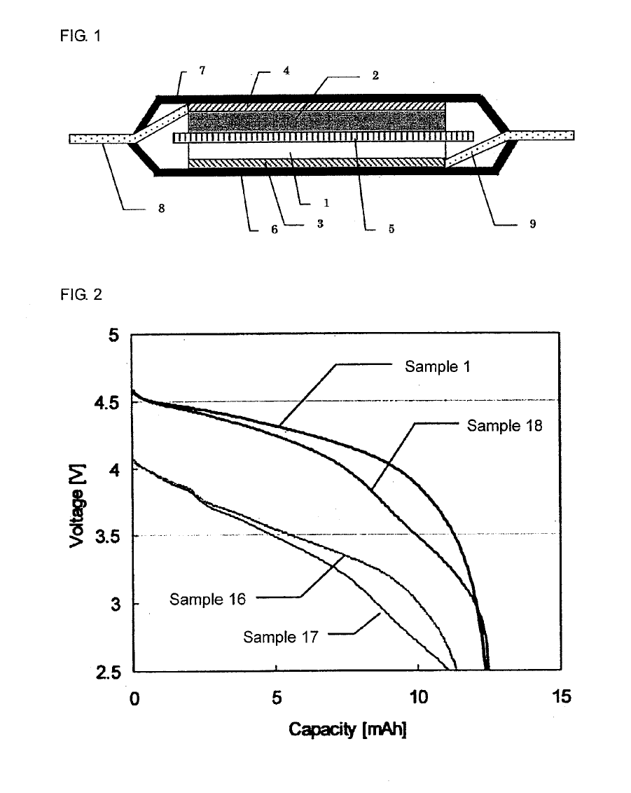

FIG. 1 shows a single-plate laminate type cell as an example of a lithium secondary battery. In this cell, a cathode 1 as a cathode active material layer which is formed on a cathode collector 3 and an anode 2 as an anode active material layer which is formed on an anode collector 3 are facing each other via a separator 5 and they are enclosed in outer laminates 6 and 7. An electrode tab 9 for the cathode connected to the cathode collector 3 and an electrode tab 8 for the anode connected to the anode collector 4 are drawn out of the laminate cell. There are no limitations to the shape of the lithium secondary battery according to the present invention. Specifically, the cathode and the anode which are facing each other via the separator may be wound or stacked and the cell may have a shape of coin-type, laminate pack, rectangular or cylindrical.

In the lithium secondary battery thus prepared, a cathode potential is preferably 5.0 V or less to Li. A higher potential may lead to decomposition of the electrolyte solvent. In particular, for ensuring battery reliability during a charge/discharge cycle or storage at a high temperature of 60° C. or higher, the cathode potential is more preferably 4.9 V or less, further preferably 4.8 V or less. An anode potential may be 0 V or more to Li. In the battery in which a complex oxide of Si and Sn is used as the active material in the anode, the voltage at the end of charging in the active material is about 0 V to Li. Therefore, a battery charge voltage corresponding to a potential difference between the cathode and the anode is more preferably 4.9 V or less, further preferably 4.8 V or less.

### EXAMPLES

### Experimental Example 1

### (Preparation of Cathode)

Cathode active materials listed in Table 1 were prepared as described below.

As raw materials, LiOH, MnO₂, Ni(OH)₂, TiO₂, Mg(OH)₂, Al(OH)₃ and SiO were weighed in such amounts that a desired metal composition ratio was obtained. These raw materials were pulverized and blended in a mortar for 5 hours or longer. The blended sample was calcined in the air at 900° C. for 12 hours. The calcined sample was again pulverized and blended, and was secondarily-calcined in the oxygen at 700° C. for 12 hours. Then, it was passed through a 25 μm mesh sieve to remove coarse particles. Thus, a cathode active material was obtained. The powder thus obtained has a specific surface area of about 0.3 to 1 m²/g and an average particle size of about 0.5 to 20 μm. X-ray diffractometry indicated that it had a spinel structure.

The cathode active material thus obtained was combined with a carbon material as a conductivity-endowing material, and was dispersed in N-methylpyrrolidone (NMP) with a dissolved polyvinylidene fluoride (PVDF, a binder) to obtain a slurry. Carbon black was used as the conductivity-endowing material. A weight ratio of the cathode active material, the conductivity-endowing material and the binder was 91/6/3. The above slurry was applied on an Al collector with a thickness of 20 μm. Then, it was dried in vacuo for 12 hours and cut into a piece with a size of 10 mm (length)×20 mm (width), which was then pressed at 3 t/cm² to form a cathode.

### (Preparation of Anode)

Raw materials for an anode active material listed in Table 1 were used to prepare an anode containing the anode active material as described below, in which the a2, the y2 and the z2 in general formula (II) were the values shown in Table 1.

SiO or SnO was deposited on a Cu collector with a thickness of 15 μm by vapor deposition in vacuo. When adding an M3 metal element such as Fe, Ni or Cu, SiO or SnO and the metal element to be added were deposited by two-component vapor deposition. A metal composition ratio was controlled by their deposition rates. Then, Li metal was vapor-deposited on the deposited anode active material layer made of the materials other than Li metal. The amount of Li metal was controlled by the deposition rate and time. The anode active material layer thus formed had an overall thickness of 1 to 15 μm. Evaluation of the anode active material by X-ray diffractometry indicated no distinct peaks. Thus, it was believed that the anode active material was amorphous. The elemental composition was determined by ICP emission spectrometry. Then, it was cut into a piece with a size of 10 mm (length)×20 mm (width) to provide an anode.

### (Manufacturing Lithium Secondary Battery)

A single-plate laminate-type lithium secondary battery was prepared, which had the configuration shown in FIG. 1. In an electrolyte used, an electrolyte solvent was a 30:70 (vol %) mixture of ethylene carbonate (EC) and dimethyl carbonate (DMC); an electrolyte-supporting salt was LiPF₆; and the concentration of the electrolyte-supporting salt was 1 mol/L.

The cathode and the anode were placed opposite to each other via a separator without electric connection, and placed in a cell. As the separator, a polypropylene film was used. The cathode collector was connected to an Al tab and the anode collector was connected to an Ni tab. These tabs were electrically connected outside of the laminated cell. Then, the cell was filled with the electrolyte and sealed.

### (Evaluation of Charge/Discharge Property of Lithium Secondary Battery)

Charge/discharge properties of the lithium secondary batteries thus prepared were evaluated as described below.

First, the lithium secondary battery prepared was charged at a constant current of 0.6 mA with an upper-limit voltage of 4.8 V, and then was discharged at a constant current of 0.6 mA with a lower-limit voltage of 2.5 V, to evaluate its charge/discharge property When LiCoO₂ or LiNi_{0.8}Co_{0.2}O₂ was used as a cathode active material, the upper-limit voltage was 4.3 V instead of the above.

Table 1 shows the evaluation results of a discharge capacity in a range of 3 V or higher. FIG. 2 shows the discharge curve for samples 1, 16, 17 and 18.

TABLE 1
variation in a discharge capacity by a cathode active material

| | | Anode active material | | | | Discharge |
|---|---|---|---|---|---|---|
| Sample | Cathode | Raw | | | | capacity |
| No. | active material | materials | a2 | y2 | z2 | [mAh] |
| 1 | LiNi_{0.5}Mn_{1.5}O₄ | Li, SiO | 2 | 0 | 1 | 12.1 |
| 2 | LiNi_{0.7}Mn_{1.3}O₄ | Li, SiO | 2 | 0 | 1 | 7.3 |
| 3 | LiNi_{0.6}Mn_{1.4}O₄ | Li, SiO | 2 | 0 | 1 | 9.2 |
| 4 | LiNi_{0.4}Mn_{1.6}O₄ | Li, SiO | 2 | 0 | 1 | 9.4 |
| 5 | LiNi_{0.3}Mn_{1.7}O₄ | Li, SiO | 2 | 0 | 1 | 7.1 |
| 6 | LiNi_{0.5}Mn_{1.45}Ti_{0.05}O₄ | Li, SiO | 2 | 0 | 1 | 12.2 |
| 7 | LiNi_{0.5}Mn_{1.4}Ti_{0.1}O₄ | Li, SiO | 2 | 0 | 1 | 12.3 |
| 8 | LiNi_{0.5}Mn_{1.35}Ti_{0.15}O₄ | Li, SiO | 2 | 0 | 1 | 12.2 |
| 9 | LiNi_{0.5}Mn_{1.3}Ti_{0.2}O₄ | Li, SiO | 2 | 0 | 1 | 12.0 |
| 10 | LiNi_{0.5}Mn_{1.2}Ti_{0.3}O₄ | Li, SiO | 2 | 0 | 1 | 11.8 |
| 11 | LiNi_{0.5}Mn_{1.1}Ti_{0.4}O₄ | Li, SiO | 2 | 0 | 1 | 11.4 |
| 12 | LiNi_{0.5}Mn_{1.48}Al_{0.02}O₄ | Li, SiO | 2 | 0 | 1 | 12.0 |
| 13 | LiNi_{0.5}Mn_{1.45}Si_{0.05}O₄ | Li, SiO | 2 | 0 | 1 | 12.2 |
| 14 | LiNi_{0.5}Mn_{1.47}Mg_{0.03}O₄ | Li, SiO | 2 | 0 | 1 | 11.8 |
| 15 | LiNi_{0.8}Co_{0.2}O₂ | Li, SiO | 2 | 0 | 1 | 7.5 |
| 16 | LiCoO₂ | Li, SiO | 2 | 0 | 1 | 9.9 |
| 17 | LiCoO₂ | Li, SiO, | 0.87 | 0.2 | 0.7 | 8.5 |
| | | Fe | | | | |
| 18 | LiNi_{0.5}Mn_{1.5}O₄ | Li, SiO, | 0.87 | 0.2 | 0.7 | 11.9 |
| | | Fe | | | | |
| 19 | LiNi_{0.5}Mn_{1.5}O₄ | Li, SnO | 1.5 | 0 | 1.1 | 11.6 |
| 20 | LiNi_{0.5}Mn_{1.5}O₄ | Li, SnO, | 0.8 | 0.2 | 1.2 | 11.5 |
| | | Fe | | | | |

when using the cathode active material having the composition of LiNi_{0.5}Mn_{1.5}O₄ or near, high capacities were obtained. It would be because the cathode active material having the composition of LiNi_{0.5}Mn_{1.5}O₄ or near has a flat and high-capacity charge/discharge curve in a potential range of 4.5 V to Li. As shown in FIG. 2, when using LiCoO₂, discharge capacities at 3 V or higher were lower. From these results, it is preferable to use the cathode active material having the composition of LiNi_{0.5}Mn_{1.5}O₄ or near when using the anode active material containing Si or Sn as a main component in the anode. As seen from FIG. 2, when adding the M3 metal such as Fe to the anode active material, the charge/discharge potential as the battery tends to be reduced. However, when using LiCoO₂ as the cathode active material, there was tendency to further reduction in the capacity as the lithium secondary battery, while when using the cathode active material having the composition of LiNi_{0.5}Mn_{1.5}O₄ or near, the reduction in the capacity was not observed.

### Experimental Example 2

Lithium secondary batteries of samples 21 to 26 using cathode active materials and anode active materials shown in Table 2 and samples 27 to 39 using cathode active materials and anode active materials shown in Table 3 were prepared in the as described in Experimental Example 1, and were evaluated for their charge/discharge properties. Tables 2 and 3 show the evaluation results for a discharge capacity in a range of 3 V or higher.

### (Evaluation of Cycle Properties of Lithium Secondary Battery)

Cycle properties of the lithium secondary batteries thus obtained were evaluated as described below.

Charging was conducted at a constant current of 12 mA with an upper-limit voltage of 4.8 V and after reaching 4.8 V, at a constant voltage until a charge time of 150 min. Discharging was conducted at a constant current of 12 mA with a lower-limit voltage of 3 V The charge/discharge cycle was repeated and variation in the discharge capacity was evaluated. The discharge capacity after 200 cycles to the initial discharge capacity was determined as a capacity retention ratio after 200 cycles. The results are shown in Tables 2 and 3.

TABLE 2
effects of M3 metal addition on an anode active material

| | | Anode active material | | | | Discharge | Capacity |
|---|---|---|---|---|---|---|---|
| Sample | Cathode | Raw | | | | capacity | retention ratio |
| No. | active material | materials | a2 | y2 | z2 | [mAh] | after 200 cycles |
| 1 | LiNi_{0.5}Mn_{1.5}O₄ | Li, SiO | 2 | 0 | 1 | 12.1 | 73% |
| 18 | LiNi_{0.5}Mn_{1.5}O₄ | Li, SiO, Fe | 0.87 | 0.2 | 0.7 | 11.9 | 79% |
| 21 | LiNi_{0.5}Mn_{1.5}O₄ | SiO | 0 | 0 | 1 | 5.3 | 42% |
| 22 | LiNi_{0.5}Mn_{1.5}O₄ | Li, SiO | 2.5 | 0 | 1 | 11.0 | 73% |
| 23 | LiNi_{0.5}Mn_{1.5}O₄ | Li, SiO, Fe | 0.5 | 0.3 | 0.6 | 11.2 | 78% |
| 24 | LiNi_{0.5}Mn_{1.5}O₄ | Li, SiO, Cu | 0.81 | 0.15 | 0.8 | 12.1 | 78% |
| 25 | LiNi_{0.5}Mn_{1.5}O₄ | Li, SiO, Ni | 1.3 | 0.1 | 0.9 | 12.0 | 75% |
| 26 | LiNi_{0.5}Mn_{1.5}O₄ | Li, SiO, Fe | 1.0 | 0.05 | 0.95 | 11.5 | 74% |

TABLE 3
effects of M1 element replacement on a cathode active material

| | | Anode active material | | | | Discharge | Capacity |
|---|---|---|---|---|---|---|---|
| Sample | Cathode | Raw | | | | capacity | retention ratio |
| No. | active material | materials | a2 | y2 | z2 | [mAh] | after 200 cycles |
| 18 | LiNi_{0.5}Mn_{1.5}O₄ | Li, SiO, Fe | 0.87 | 0.2 | 0.7 | 11.9 | 79% |
| 27 | LiNi_{0.5}Mn_{1.45}Ti_{0.05}O₄ | Li, SiO, Fe | 0.87 | 0.2 | 0.7 | 12.1 | 79% |
| 28 | LiNi_{0.5}Mn_{1.4}Ti_{0.1}O₄ | Li, SiO, Fe | 0.87 | 0.2 | 0.7 | 12.1 | 85% |
| 29 | LiNi_{0.5}Mn_{1.35}Ti_{0.15}O₄ | Li, SiO, Fe | 0.87 | 0.2 | 0.7 | 12.2 | 89% |
| 30 | LiNi_{0.5}Mn_{1.3}Ti_{0.2}O₄ | Li, SiO, Fe | 0.87 | 0.2 | 0.7 | 12.1 | 88% |
| 31 | LiNi_{0.5}Mn_{1.2}Ti_{0.3}O₄ | Li, SiO, Fe | 0.87 | 0.2 | 0.7 | 11.5 | 82% |
| 32 | LiNi_{0.5}Mn_{1.1}Ti_{0.4}O₄ | Li, SiO, Fe | 0.87 | 0.2 | 0.7 | 10.6 | 80% |
| 33 | LiNi_{0.5}Mn_{1.35}Ti_{0.15}O₄ | Li, SiO, Fe | 0.77 | 0.1 | 0.85 | 12.1 | 86% |
| 34 | LiNi_{0.5}Mn_{1.35}Ti_{0.15}O₄ | Li, SiO, Fe | 0.86 | 0.15 | 0.8 | 12.1 | 84% |
| 35 | LiNi_{0.5}Mn_{1.48}Al_{0.02}O₄ | Li, SiO, Fe | 0.87 | 0.2 | 0.7 | 11.8 | 74% |
| 36 | LiNi_{0.5}Mn_{1.45}Si_{0.05}O₄ | Li, SiO, Fe | 0.87 | 0.2 | 0.7 | 12.2 | 78% |
| 37 | LiNi_{0.5}Mn_{1.47}Mg_{0.03}O₄ | Li, SiO, Fe | 0.87 | 0.2 | 0.7 | 11.7 | 73% |
| 38 | LiNi_{0.5}Mn_{1.3}Al_{0.03}Ti_{0.17}O₄ | Li, SiO, Fe | 0.87 | 0.2 | 0.7 | 12.0 | 85% |
| 39 | LiNi_{0.5}Mn_{1.35}Si_{0.02}Ti_{0.13}O₄ | Li, SiO, Fe | 0.87 | 0.2 | 0.7 | 12.2 | 87% |

As shown in Table 2, it was found that even when the M3 metal was added to the anode active material, the cycle properties were satisfactory and particularly, high capacities and high improvements of the cycle properties were obtained when using the anode active material in which the a2 satisfied 0.5≦a2≦2.5 and the y3 satisfied 0.05≦y2≦0.3. When Li was not added to the anode active material, the capacity as the battery was lower. It would be because without Li addition, an irreversible capacity was prominent in the anode.

As shown in Table 3, it was found that when replacing Mn in LiNi_{0.5}Mn_{1.5}O₄ with another M1 element, the cycle properties were improved while maintaining the high initial capacity. In particular, when the M1 in the general formula (I) contained Ti, the cycle properties were prominently improved and furthermore the effects were particularly prominent when 0<y1≦0.4.

As described above, a cathode active material represented by general formula (I) and an anode active material represented by general formula (II) can be used to prepare a lithium secondary battery with a high capacity and a longer life.

### INDUSTRIAL APPLICABILITY

Examples of applications in which a lithium secondary battery according to the present invention can be used, include batteries for a cell phone, a notebook computer, an automobile, an uninterruptible power source and a portable music device.

What is claimed is:

1. A lithium secondary battery comprising:
a compound represented by general formula (I) described below as a cathode active material: and
a compound represented by general formula (II) described below as an anode active material;
Liₐ₁(Niₓ₁Mn_{2-x1-y1}M1_{y1})O₄ (I)
wherein the M1 is at least one selected from the group consisting of Ti, Si, Mg, and Al, and comprises Ti and Al, the al satisfies 0≦a1≦1, the x1 satisfies 0.4≦x1≦0.6, and the y1 satisfies 0<y1≦0.4; and
Liₐ₂M2_{1-y2}M3_{y2}O_{z2} (II)
wherein the M2 is at least one selected from the group consisting of Si and Sri, the M3 is at least one selected from the group consisting of Fe, Ni and Cu, the a2 satisfies 0.5≦a2≦2.5, the y2 satisfies 0.05≦y2≦0.3, and the z2 satisfies 0<z2<2.

2. The lithium secondary battery as claimed in claim 1, wherein the M3 comprises Fe.

3. The lithium secondary battery as claimed in claim 1, wherein the y1 satisfies 0.02≦y1≦0.4 in the general formula (I).

4. The lithium secondary battery as claimed in claim 1, wherein the y1 satisfies 0.02≦y1≦0.2 in the general formula (I).

5. The lithium secondary battery as claimed in claim 1, wherein the y1 satisfies 0.1≦y1≦0.4 in the general formula (I).

6. The lithium secondary battery as claimed in claim 1, wherein the y1 satisfies 0.1≦y1≦0.3 in the general formula (I).

7. The lithium secondary battery as claimed in claim 1, wherein the y1 satisfies 0.1≦y1≦0.2 in the general formula (I).

8. The lithium secondary battery as claimed in claim 1, wherein the y2 satisfies 0.1≦y2≦0.3 in the general formula (II).

9. The lithium secondary battery as claimed in claim 1, wherein the y2 satisfies 0.05≦y2≦0.2 in the general formula (II).

10. The lithium secondary battery as claimed in claim 1, wherein the cathode active material has a specific surface area of 0.01 m²/g to 3 m²/g.

11. The lithium secondary battery as claimed in claim 1, wherein a cathode comprises the cathode active material, a conductivity-endowing material, and a binder in an amount of 70 to 98.5% by weight, 0.5 to 30% by weight, and 1 to 10% by weight, respectively, relative to the total amount of the cathode active material, the conductivity-endowing material, and the binder.

12. The lithium secondary battery as claimed in claim 1, wherein an anode collector contains the anode active material deposited thereon.

13. The lithium secondary battery as claimed in claim 1, wherein a cathode containing the cathode active material and an anode containing the anode active material are separated by a separator and immersed in a lithium-ion conducting electrolyte.
